(19) United States
(12) Patent Application Publication
(10) Pub. No.: US 2002/0010522 A1
(43) Pub. Date: Jan. 24, 2002

(54) Method and apparatus for home design and building

(76) Inventor: J. David Martin, San Francisco, CA (US)

Correspondence Address: Sheldon R. Meyer, Esq., FLIESLER DUBB MEYER & LOVEJOY LLP, Four Embarcadero Center, Fourth Floor, San Francisco, CA, 94111-4156, US

(21) Appl. No.: 09/784,224

(22) Filed: Feb. 15, 2001

Related U.S. Application Data
(60) Provisional application No. 60/182,680, filed on Feb. 15, 2000.

(51) Int. Cl. G06F 19/00

(52) U.S. Cl. 700/97

(57) ABSTRACT

A system for designing houses according to a consumers specifications is described herein. The system allows building design element vendors such as housing component manufacturers, developers, designers and service providers to contribute detailed agreements about their products or services to a central service provider. The agreements include data which is used to modify the available options and features displayed at a home page maintained by the service provider. The user accesses the home page via the Web and uses it to select, design, customize, and purchase their new home.

This application claims priority from provisional application “A METHOD AND APPARATUS FOR HOME DESIGN AND BUILDING”, application Ser. No. 60/182,680, filed Feb. 15, 2000, and incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates generally to the area of custom house design, and to systems for designing custom buildings.

### BACKGROUND OF THE INVENTION

The methods used today for designing and building homes has changed little in the past several hundred years. Traditional homebuilders still utilize the historic methods of construction that rely on sub-contractors to get the job completed. Typically, several sub-contractors are used to stage or to erect the structure on-site by referring to a set of plans. Often these plans will be incomplete or inaccurate. As a result, construction materials are inefficiently field —measured at the site itself during the actual construction. This leads to wasted materials, imperfect fitting, and an often imperfect finished product.

As a further issue, the timing of the entire construction project is impacted by weather, the availability of third party crews and sporadic building inspections. The whole process can take from 90-120 days. The overriding consequence is that costs for buildings constructed according to such historically used methods are high, ranging from $200/square foot for a single or custom design, to $80/square foot for mass-produced design (costs given are typical 2000 levels).

At the entry level of the home buying scale home buyers are offered a limited selection of possible home choices in an attempt to standardize design, and to minimize construction changes. In doing this, neighborhoods lose their originality and character and instead become “subdivisions” and “tracts”. The consumer is faced with ever higher prices and a limited set of home choices. Nonetheless, home buyers in the United States continue to acquire over $100 billion worth of new homes each year.

Manufactured homebuilders have developed out of the mobile home industry. A mobile home is characterized by modularity, a prevalence of standard components and sizes, and ease of construction. Manufactured homebuilders have taken the factory-based manufacturing efficiencies of the mobile home industry and have applied them to the low end of the single family housing market. Costs for homes constructed using these methods are typically around $40/square foot (2000 levels), and the quality of such homes is comparable to or better than entry level site-built homes constructed according to traditional methods of design. Manufactured homebuilders however usually only offer a limited range of options, and market the homes through an outdated and comparatively unsophisticated dealer network, much like their mobile home brethren. Today, manufactured housing in the United States is being built at a rate of $14 billion annually and represents 29% of all new housing. The nationwide plants producing these homes are operating at a current utilization rate of less than 50%.

One of the most significant advances in the construction and home building industry is the development of computer aided design (CAD). The benefits and features of computer aided design applications have significantly advanced in recent years and it is now a standard platform for the majority manufactured homebuilders and for most architects. CAD technology allows for the introduction of significant design and construction flexibility in the building process and provides detailed construction ready specifications in an electronic format that can be reviewed and approved with minimal lag time via online resources such as the Web or e-mail.

Architects who have achieved recognition in their field for creating outstanding designs are now searching for opportunities to bring their designs to the masses. As an example, some renowned architects and designers, have designed housewares to be sold in department stores nationwide. This design trend is part of an overall shift in consumer marketing practices, which have redefined consumer value as the combination of great design, individual consumer choice, and low cost. Some watch manufacturers have revolutionized the watch industry by pioneering this approach of utilizing well-known contemporary designers, a large and ever expanding range of choices, and a large manufacturing base that allow them to achieve a price point that makes their product economically accessible to the masses.

Local developers currently dominate the home-building industry. Their greatest competition is the regional homebuilders, who despite their purchasing power currently operate at a small net margin of approximately 5%. Regional homebuilders focus their efforts almost entirely on large tracts of land, employing a business model that is depends on standardization, high volume, and low margins. In order to complete, local developers must be continually on the lookout for any competitive advantages they can leverage to combat the economies of scale enjoyed by the regional builders.

Another common aspect of the current home building industry is the presence of market gaps between the existing manufactured housing buyer and the traditional entry-level site-built buyer. In many cases, a consumer may choose to rent when the market gap is too wide or the choices available within the two extents are not appealing. There is currently no intermediate option that is flexible enough to suit the needs of a large portion of available consumers.

The United States market is not alone in facing these challenges the problem extends on an international and indeed global scale. International markets represent a currently under served opportunity. The countries with the largest populations, China, India and Mexico, all have “baby boom” demographic profiles and affordability crises. If they are not currently experiencing shortages in affordable and desirable housing, they may well soon, and now is the time to specifically target such a problem with new and interesting solutions.

### SUMMARY OF THE INVENTION

The invention proposes a solution to the often overlooked ‘middle ground’ of property construction and particularly home building. Roughly described, the invention provides a system for allowing a user, who may be either a prospective home buyer, a sales agent, a property developer or any other person or entity interested in building management, to customize and specify a new home using a standard set of home shapes and components. This approach allows a diverse group of participants, builders, contractors, and consumers to work together for the benefit of all the participants.

With multiple sources for each relationship accessed via a Web site consumers benefit with greater value: expanded choices, better design, better quality and lower costs. The invention allows consumers to drive the home buying experience instead of the developers. They have the option of accessing the Web site via the Web itself or at the location (sales office) of a “franchised” developer.

Local Developers benefit by having more competitive products to offer consumers. Well known architects can benefit from using the invention by receiving a design fee each time one of their designs is sold or used in designs of a job site or home. Manufactured Homebuilders benefit from the increased utilization of their existing plants. Several manufacturing companies may be affiliated to provide geographic coverage throughout the nation and ensure adequate capacity coverage.

In one embodiment, the invention comprises a mechanism for building design and construction, comprising: a server hosting a communications device for communicating with a user; a design device controlled by inputs received from a user via said communications device; a user interface device configured to communicate a user interface to said user, said user interface providing any of selection, arrangement or other modification of design features of a building in a format readable by said user; and an ordering mechanism to order building and shipment of parts and labor required to construct the designed building.

In another embodiment, the invention comprises a system for allowing a user to create a custom building design, comprising a central server having stored thereon a database of building design elements, wherein each entry in said database describes a building design element data and includes the availability and the design characteristics of said building design element; a communications link to a building design element vendor for obtaining said building design element data; a user interface for presenting a set of available design options to a user, and for receiving from said user a set of preferred design options; and, a database processor for updating the contents of the database with updated building design element information received from the vendor.

In a further embodiment, the invention comprises a system for building design and construction comprising: a server hosting communications with entities including consumers, manufacturers, developers, designers and suppliers, wherein said server stores data for said entities; a design device that can select among the data stored by said server; a user interface device that can allow a user to make design and construction selections from the data stored on said server; and, an ordering mechanism that the user can use to order the design and construction selections.

### BRIEF DESCRIPTION OF THE DRAWINGS

FIG. 1 is a schematic showing the relationships between business entities and a web site provided by the invention.

FIG. 2 is a schematic of a web site accessible system in accordance with the invention showing, one embodiment of a CAD configuration that provides users with an interface for changing and altering home design and altering modules.

FIG. 3 is a simplified example of one possible embodiment of a high-level page for a web site, featuring Design, Mortgage, Equipment, and Furnishings sub pages that represent vendors who may be utilized in home design.

FIG. 4 is an example of a tab layout of rooms, selection pulldowns and check boxes for room design.

FIG. 5 is a flow chart of the processes performed by a user in design in a home.

FIG. 6 is a flow chart of the interrelated processes used to design and build a home to a users specification.

### DESCRIPTION OF THE EMBODIMENTS

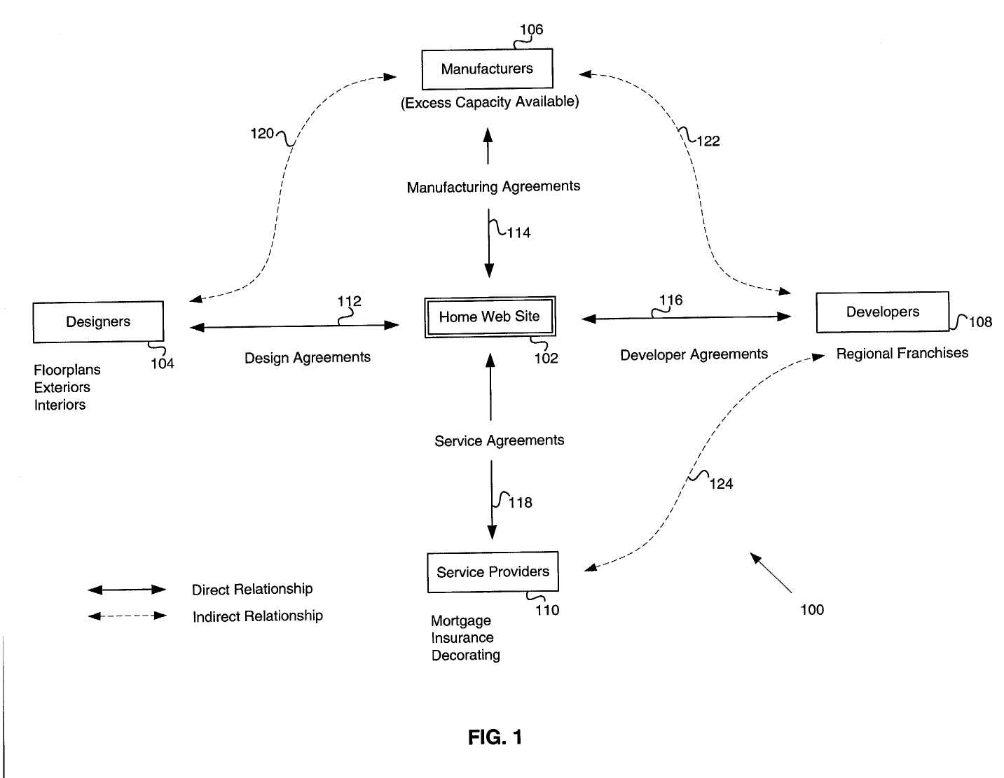

The invention allows a diverse group of participants, builders, contractors, and consumers to work together for the benefit of all the participants. FIG. 1 illustrates some of the business relationships that may be supported by the present invention. These include designers (floorplans, exteriors, interiors), manufacturers, service providers (mortgage brokers, insurance companies), and developers.

With multiple sources for each relationship accessed via a Web site consumers benefit with greater value: expanded choices, better design, better quality and lower costs. The invention allows consumers to drive the homebuying experience instead of the developers. They have the option of accessing the Web site via the Web itself or at the location (sales office) of a “franchised” developer.

Local developers benefit by having more competitive products to offer consumers. They may act as regional members. In this instance their responsibility includes the same responsibilities they now have in their existing business but the design and marketing of the home can be performed on the system provided by the invention. The construction of the home is then undertaken at a nearby affiliated plant and delivered to the job site. The shorter timeline for final product delivery reduces the developer's carry costs and contribute directly to his bottom line profit.

Well known architects can benefit from using the invention by receiving a design fee each time one of their designs is sold or used in designs of a job site or home.

The manufactured homebuilders benefit from the increased utilization of their existing plants. Several manufacturing companies may be affiliated to provide geographic coverage throughout the nation and ensure adequate capacity coverage.

In one embodiment, a computer assisted design (CAD) program is utilized as a back-end with a customized consumer interface on the front end. Homes are designed by the architects using the CAD program in a modular format such that each building module, section or design element can be built in the plant and transported to the site. Any CAD program or application can be used, but in most cases the best choice for CAD will be to choose the version the manufacturing plants are already utilizing for their current manufacturing practices. This is invariably AutoCad (from AutoDesk Inc.) although any comparable product could be used. Conversion routines may also assist in communication data from the designer to the manufacturer.

The module design format allows the consumer to mix and match building components or design elements. Once the basis floor plan is chosen by the consumer, the home can be displayed in three-dimensions (3D) to allow selection of exterior and interior options. While the design and display process is being performed, the system can allow an automatic price to be computed and shown on the screen with every decision.

By including a financial questionnaire and a mortgage calculator, or incorporating existing on-line mortgage technologies (mortgage.com, for example), the consumer can input all their financial data to understand what financial programs are available and how much they can afford. This information can help drive their design and options decisions.

FIG. 1 shows an overview of a system according to the invention, and illustrates how the various entities may work together via a central location or service provider. The service provider may include a Web site 102, through which the separate entities communicate. Other forms of central or distributed communication mechanisms can be used, including file transfer protocol, hypertext transfer protocol, extensible markup language (XML) and electronic mail data transfers. Home designers 104 may communicate their designs, including floorplan, exterior and interior design via a series of design agreements 112. Similarly, manufacturers 106 may communicate information about their manufacturing capabilities and available capacity via a series of manufacturing agreements 114. Developers 108, which may include local and regional site developers can communicate information about their potential sites and franchises via developer agreements 116. Additional service providers 110, for example mortgage and insurance brokers, decorating companies, etc., can communicate via service agreements 118. The result is an infrastructure of manufacturers, designers, developers and service providers that are connected to each other via a series of direct links or relationships to a central service provider. Each of these manufacturers, designing or service providing entities contributes a design element to the system. The design elements are stored in a database at a central location where they may be chosen by a user in selecting preferred building components or design options. In one embodiment, indirect links or relationships 120, 122, 124, allow the various entities to also communicate with each other independently of the central provider. The data transferred by indirect links need not be stored at a central location accessible by a user.

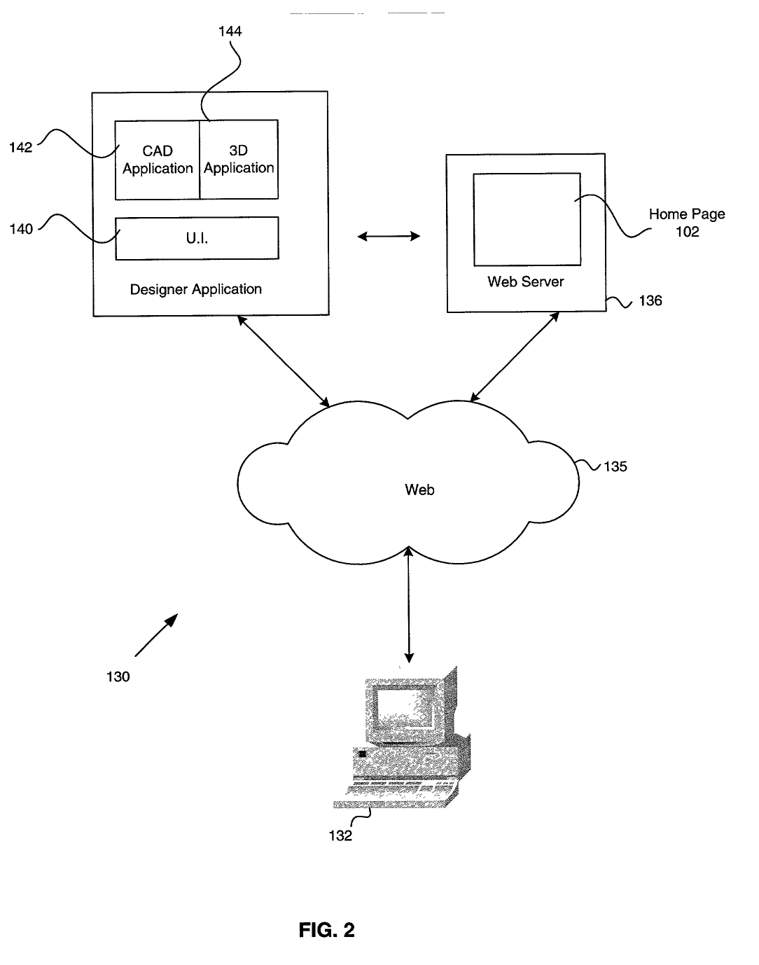

FIG. 2 illustrates one embodiment of how a user may use the system. As used herein, the term user is used to refer to any end-customer, property developer, or realtor that may use the system to design new homes or structures. The user, either at home or at a client site accesses a designer application 134. The designer application includes a user interface 140, CAD application components 142, and a 3D component 144. The user interface may be specially modified to allow a user to operate the CAD functions with little or no previous experience. It can also be modified to only allow a user to specify design elements or components that are currently offered by the manufacturers or designers. In one embodiment the user accesses designer application 134 via the Web 135 (or any other Internet protocol) and a web server 136 acting as a host or service provider. Typically this will be via a Web home page 102 that is shared with or in communication with the entities shown in FIG. 1.

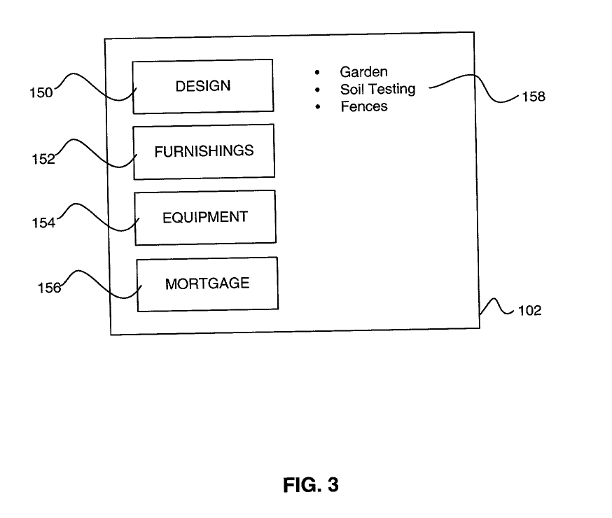

The typical components of one embodiment of a Web home page 102 are shown in FIG. 3. The home page includes links for design 150, furnishings 152, equipment 154, and mortgage 156. These allow a user to fully specify the new home or building. Additional options and services 158 such as garden, soil testing, and fencing can be added to the home page as necessary. It will be evident to those skilled in the art that additional links to service providers can be added and that the invention should not be limited to the features shown here for example purposes.

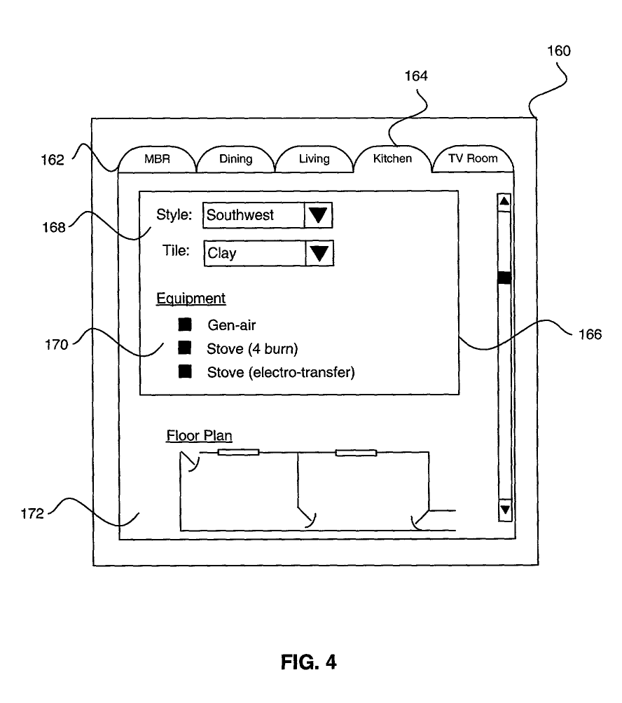

FIG. 4 illustrates an embodiment of a feature selection screen 160 accessible to the user via the home page. Along the top of the screen appear a number of feature selection tabs 162. These tabs are used to select areas of the building to be customized or designed. Selecting a tab, such as the kitchen tab 164 brings that area to the forefront of the screen. The user may then make selections to customize their room (the kitchen in this example) from a feature selection area 166 that includes pull-down selectors 168 and a check base selectors 170. As each selection is made a floorplan of the room, or the entire building, is generated and displayed on screen together with any selected building design elements 172.

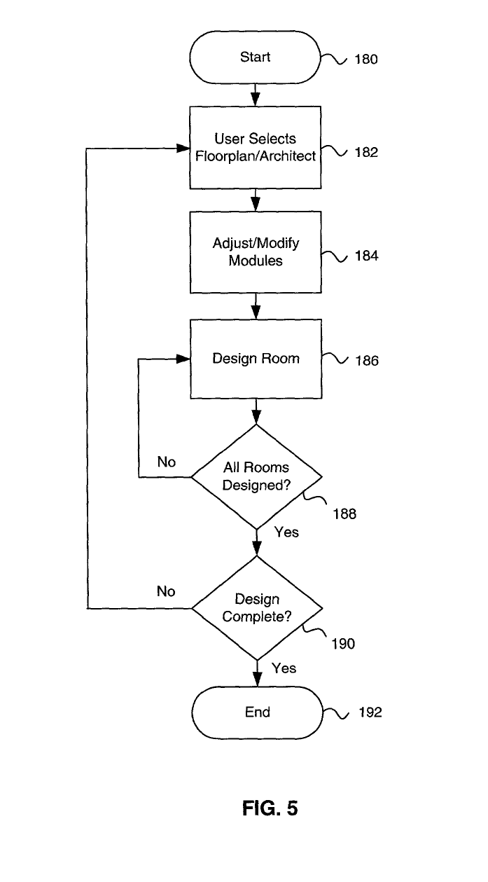

The process for designing such a room using the invention is shown in FIG. 5. The process is started by accessing the Web page (step 180). In step 182, a user first selects a floorplan and/or an architect to base their design upon. The building modules or components are adjusted as necessary (step 184). The user then designs each room in turn, (step 186) adding design features, interiors, etc., until all of rooms have a design specification (step 188). At this point the user may return to add more building components, extra rooms perhaps (step 190). If the user is finished they may end the program (step 192). A copy of their design specification is saved in the system for later use.

The Consumer Experience

In using one embodiment of the invention, the home buyer may first take a physical tour of a model home, where he/she will have an opportunity to see and feel the quality of the home. During this time, the consumer can become acquainted with the system and gain an understanding of the options and the unique advantages available to them. After all of their questions have been answered and they are comfortable with using the system, a salesperson can sit down with them to help them design their own, personal and customized home. The web site can be designed to include a list of model homes in close proximity to a user's location, together with viewing hours and directional maps. The user can then go to a sales office, or utilize the web site from his/her home PC to produce a design.

In one embodiment (after logon, for example), the web site displays a first series of screens that ask the consumer some basic lifestyle question to help the system recommend certain products (for example, that they are outdoors type, indoors person, car-owner, pets-owner, etc.).

The next series of screens (or selectable tab options, for example) leads the consumer through each room of the home, one at a time. Once the decision is made, the selection is saved and the next room is considered. When all rooms have been chosen, the entire floor plan is displayed for inspection and changes. 3D viewing is also available. Interior options such as stereo systems, lighting plans, kitchen appliances, finishes, etc., may be added, as can the exterior options like Cape Cod, Tudor, Modern, etc. style. The final design can then be saved or printed as a color brochure with detailed specifications and a complete pricing list.

Completing the Process

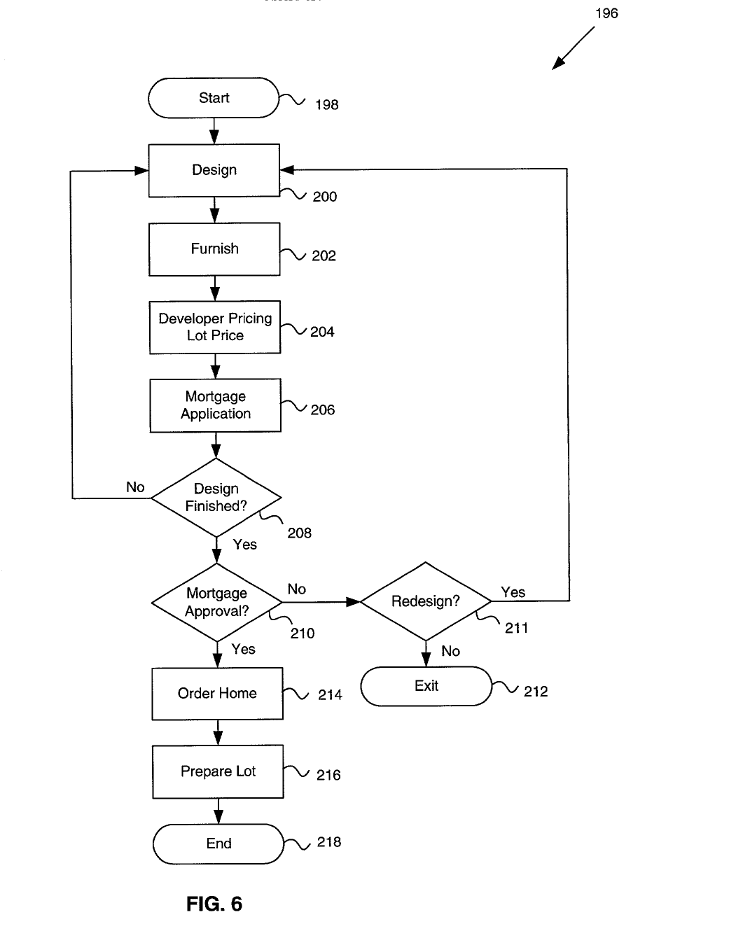

FIG. 6 illustrates one embodiment of the invention which utilizes the services of other entities to complete the process. The user first designs (step 200) and furnishes or otherwise determines the property interior (step 202). This information is used to calculate the price of the lot as determined by information supplied by the developer (step 204). The user may complete a mortgage application online to cover the cost of their design (step 206). If the user is satisfied with their design the mortgage may be approved (step 210). If for some reason the mortgage approval fails, the design may be reworked (step 211) to fit within the user's budget. A successful mortgage approval allows the user to proceed to order the home (step 214). Instructions to that effect are then delivered to the developer (step 216) and the building is constructed.

Once the consumer is qualified online through a mortgage broker, an escrow is opened and the order is e-mailed to the manufacturing plant for home construction and to the local developer for site work. The home can generally be built in the plant within 30 days as compared to 120-180 days for site-built homes. At the same time, the local developer prepares the site with any necessary improvements like a foundation and driveway which can generally be completed before the home is delivered. Once the delivery is made, the local developer completes the installation within 30 days and escrow closes.

When escrow closes, the manufacturer is paid, the architect receives a fee, the central service provider (hosting the Web site) is paid its fee, and the developer recovers his local expenses and receives his profits.

The present invention may be conveniently implemented using a conventional general purpose or a specialized digital computer or microprocessor programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, user interface modules for connecting a user to a CAD design application (Auto-CAD, for example), furnishings, home developer, and other home purchasing software and communications links, database programming and related software for storing user (customer) and designer designs, floor plans and product selections, html programming for presentation of the website and associate links, applications, and other functions, and the display, storage, or communication of results according to the processes of the present invention.

Web Site as used herein is intended to be broadly construed to include any configuration of servers, computers, routers, store/forward, and peripheral equipment devices that are either directly connected, connected via a network, or otherwise coupled or utilized in conjunction to provide the web page and related links and resources to a user (end user, customer, supplier, content provider, service provider, etc.) or other individual or system that utilizes the web site. For example, the web site or server contains a database of products that may be viewed, selected, added to, or modified by a user. The database program may run on a same computer device physical server as the server (a) which sends virtual and other page-related information (applets, graphics, etc.) to a user's computer, or may be located on a separate computing device coupled to the server (a).

Obviously, numerous modifications and variations of the present invention are possible in light of the above teachings. It is therefore to be understood that within the scope of the appended claims, the invention may be practiced otherwise than as specifically described herein.

Industrial Applicability

The system described by the invention answers a need to bridge the gap between low-end mobile home type developments and higher end site-built developments. The technology will be of interest to local developers and manufactured housing companies, eventually including the larger regional homebuilders.

The invention is well positioned to withstand competition with its ability to help develop a structure that enjoys lower overhead, due to the outsourced business features. As such, the invention should be welcomed in an industry that has not had a significant technology breakthrough in over 100 years.

Most national and local builders operate on a 5% net margin. The inventors believe that the net margin opportunity using the invention is closer to 30%. The pricing strategy should be to price the end product close to the site-built alternatives, while selling the consumer the benefits of home customization and quality design. There is plenty of margin to include the various players; including designers, local developers, and the service provider hosting the service.

What is claimed is:

1. A mechanism for building design and construction, comprising:
a server hosting a communications device for communicating with a user;
a design device controlled by inputs received from a user via said communications device;
a user interface device configured to communicate a user interface to said user, said user interface providing any of selection, arrangement or other modification of design features of a building in a format readable by said user; and
an ordering mechanism to order building and shipment of parts and labor required to construct the designed building.

2. The mechanism of claim 1, wherein:
said building being designed is a manufactured home, and said ordering mechanism includes,
selection of one or more home manufacturers for building one or more modules of the designed home; and
selection of any one or more of multiple local and regional contractors to prepare a site for placement of said home.

3. The mechanism of claim 1, further comprising a communication mechanism configured to at least one of
(1) calculate a buying-power qualification of said user based on user financial inputs; and
(2) send financial inputs to an outside analyst for calculation of a buying-power qualification.

4. The mechanism of claim 1, where said design device and said user interface are applications stored on a Web-accessible computer and said communications device is a hypertext transfer protocol server.

5. The mechanism of claim 1, wherein said design device is a computer assisted design application.

6. The mechanism of claim 4, wherein said user interface device is a hypertext transfer protocol page maintained on the server.

7. The mechanism of claim 1 wherein a list of design features is maintained on the server.

8. The mechanism of claim 7, wherein said list of design features includes values denoting the availability and cost of the design feature.

9. The mechanism of claim 7, wherein said list of design features is communicated to the server from a vendor supplying the design feature.

10. A system for allowing a user to create a custom building design, comprising:
a central server having stored thereon a database of building design elements, wherein each entry in said database describes a building design element data and includes the availability and the design characteristics of said building design element;
a communications link to a building design element vendor for obtaining said building design element data;
a user interface for presenting a set of available design options to a user, and for receiving from said user a set of preferred design options; and,
a database processor for updating the contents of the database with updated building design element information received from the vendor.

11. The system of claim 10 wherein said user interface includes a computer assisted design application for generating a display of the building with said preferred design options.

12. The system of claim 10 wherein said central server is a Web server and said user interface is a Web page hosted on said Web server.

13. The system of claim 10 wherein said communications link includes an Internet transfer protocol for the relay of building design element data from said building design element vendor to said central server.

14. The system of claim 13 wherein the content of said Internet transfer protocol is defined by any of a file transfer protocol, hypertext transfer protocol, extensible markup language, or electronic mail communication.

15. The system of claim 10 wherein said communications link includes the transfer of a building element supply agreement from a vendor to the central server, said supply agreement including at on a building design element.

16. The system of claim 10 wherein said vendor is a manufactured building component manufacturer.

17. The system of claim 10 wherein said vendor is a property lot developer.

18. The system of claim 10 wherein said vendor is a building element designer.

19. The system of claim 10 further comprising:
an order processor for preparing an order to construct a building incorporating said preferred design options.

20. The system of claim 19 wherein said order is sent to a vendor supplying the building design element.

21. The system of claim 20 wherein one or more vendors are selected to fulfill the order.

22. The system of claim 19 further comprising a finance processor for determining the cost of constructing said building and qualifying the user to purchase said building.

23. A method for design and construction of manufactured homes, comprising
receiving, via inputs received from a user interface, a selection, arrangement or other modification of design features of said manufactured home;
selecting one or more home manufacturers for building one or more modules of the designed home;
selecting of any one or more of multiple local and regional contractors to prepare a site for placement of said home; and,
ordering the building and shipment of parts and labor required to construct the designed device.

24. The method according to claim 23, further comprising at least one of:
(1) calculating buying-power qualifications of said user based on user financial inputs; and
(2) sending financial inputs to an outside analyst for buying-power qualifications.

25. The method according to claim 23, wherein said step of receiving inputs from a user is via a Web site and a hypertext transfer protocol server.

26. A method for allowing a user to customize a building design by selecting a set of building element components, comprising:
retrieving at a central server a building design element database, wherein each entry of said database includes the availability and the design characteristics of said building element;
updating said database with building design element data received from a building element vendor; and,
receiving at a user interface a set of preferred design options, chosen from a set of available design options, wherein each design option describes the design characteristics of a particular building element.

27. The method of claim 26, further comprising
displaying to the user a drafted design of the building with said preferred design options.

28. The method of claim 26 wherein said step of receiving is by the Internet, at a Web page in communication with said central server.

29. The method of claim 26 wherein said step of updating includes communicating by an Internet transfer protocol building element data from said building element vendor to said central server.

30. The method of claim 29 wherein the content of said Internet transfer protocol is defined by any of a file transfer protocol, hypertext transfer protocol, extensible markup language, or electronic mail communication.

31. The method of claim 26 further comprising the step of:
preparing an order to construct a building incorporating said preferred design options.

32. The method of claim 31 further comprising the step of:
sending said order to a vendor supplying the building design element.

33. The method of claim 32 further comprising the step of:
selecting one or more vendors are selected to fulfill the order.

34. The method of claim 26 further comprising the step of:
determining the cost of constructing said building and qualifying the user to purchase said building.

35. A system for building design and construction comprising:
a server hosting communications with entities including consumers, manufacturers, developers, designers and suppliers, wherein said server stores data for said entities;
a design device that can select among the data stored by said server;
a user interface device that can allow a user to make design and construction selections from the data stored on said server; and,
an ordering mechanism that the user can use to order the design and construction selections.

36. The system of claim 35, wherein said building being designed is a manufactured home, and said ordering mechanism includes,
a selection for any one or more home manufacturers for building one or more modules of the designed home; and
a selector for any one or more of multiple local and regional contractors to prepare a site for placement of said home.

37. The system of claim 35, further comprising a communication mechanism configured to at least one of
(1) calculate a buying-power qualification of said user based on user financial inputs; and
(2) send financial inputs to an outside analyst for calculation of a buying-power qualification.

38. The mechanism of claim 35, where said design device and said user interface device are applications stored on a Web-accessible computer and said communications device is a hypertext transfer protocol server.

39. The mechanism of claim 35, wherein said design device is a computer assisted design application.

40. The mechanism of claim 38, wherein said user interface device is a hypertext transfer protocol page maintained on the server.

41. The mechanism of claim 35, wherein a list of design features is maintained on the server.

42. The mechanism of claim 41, wherein said list of design features includes values denoting the availability and cost of the design feature.

43. The mechanism of claim 41, wherein said list of design features is communicated to the server from a vendor supplying the design feature.
